(19) United States
(12) Patent Application Publication
(10) Pub. No.: US 2026/0098996 A1
(43) Pub. Date: Apr. 9, 2026

(54) COATING A FIBRE, PARTICULARLY AN OPTICAL FIBRE, WITH A BORON NITRIDE-BASED COATING

(71) Applicants: CENTRE NATIONAL DE LA RECHERCHE SCIENTIFIQUE, Paris (FR); COMMISSARIAT A L'ENERGIE ATOMIQUE ET AUX ENERGIES ALTERNATIVES, Paris (FR); UNIVERSITE DE LILLE, Lille (FR)

(72) Inventors: Rémy BERNARD, La Madeleine (FR); Aymeric PASTRE, Lesquin (FR); Laure LAGO RACHED, Gif-sur-Yvette Cedex (FR)

(73) Assignees: CENTRE NATIONAL DE LA RECHERCHE SCIENTIFIQUE, Paris (FR); COMMISSARIAT A L'ENERGIE ATOMIQUE ET AUX ENERGIES ALTERNATIVES, Paris (FR); UNIVERSITE DE LILLE, Lille (FR)

(21) Appl. No.: 18/992,799

(22) PCT Filed: Jul. 10, 2023
(86) PCT No.: PCT/EP2023/068997

§ 371 Date: Jan. 9, 2025

(30) Foreign Application Priority Data
Jul. 12, 2022 (FR) 2207160

(51) Int. Cl. G02B 6/02; C03C 25/105; C03C 25/1065; C03C 25/42; C03C 25/47

(52) U.S. Cl. CPC G02B 6/02395; C03C 25/105; C03C 25/109; C03C 25/42; C03C 25/47

(57) ABSTRACT

A fibre comprising a core made of a fiberisable material and having an outer surface is described. the fibre further includes an external coating including a mixture of hexagonal boron nitride and bentonite, in a proportion of at least 10% by weight of bentonite relative to the total weight of the external coating. An optical component comprising one or more of the optical fibre is also described, along with a method for manufacturing a pasty composition for a fibre coating.

### TECHNICAL FIELD

The present invention relates to coating of fibres, in particular optical fibres with a boron nitride (BN) based coating, and also to the manufacture of such fibres. The present invention also relates to optical components comprising such optical fibres.

### PRIOR ART

The use of boron nitride in a protective coating of optical fibres.

Thus, international application WO2020/222152^{[1]} describes a method for coating an optical waveguide with boron nitride, in the form of nanotubes (BNNT). Nonetheless, this method has the drawback of being able to be implemented only to cover short lengths, as they require the prior implementation of a primer layer and/or texturing of the surface of the waveguide (in particular by hydrofluoric HF acid attack). These deposition methods involving a primer layer are not compatible with a deposition over long lengths of optical fibre. Furthermore, such a method is very expensive as it requires the synthesis of BN nanotubes.

Moreover, BN/SiBCN coatings on silica fibres and sapphire[2, 3, 4] fibres are also known to a person skilled in the art. The deposition process implemented in this case is a chemical vapour deposition process enabling a deposition of 2.5 μm thickness for a deposition time of 24 hours. It cannot be applied on long fibres.

Finally, the Chinese patent application CN106066508 describes a sheathing material of a fibre comprising a polyetheretherketone and a mixture of inorganic fillers comprising talc, limestone, calcium carbonate, barium sulphate, boron nitride, silicon dioxide or bentonite (yet bentonite or boron nitride are not mentioned as used in combination). An objective of such a coating is to increase the elongation resistance of the fibre. Furthermore, this inorganic sheathing material is not applied directly over the fibre. Its refractory properties do not seem to be the desired properties. It is used as a filling material and not as an actual coating. Finally, nothing is said about the length of the fibre or the thickness of the coating.

Nonetheless, none of the mentioned documents teaches a method for making an adherent coating on long fibres, and which further has a high resistance at low and high temperatures and to mechanical stresses.

### DESCRIPTION OF THE INVENTION

In order to solve the aforementioned problems, the Applicant has developed a fibre comprising a core made of a fiberisable material and having an outer surface, said fibre being characterised in that it further includes an external coating including a mixture of hexagonal boron nitride and bentonite, in a proportion of at least 10% by weight of bentonite relative to the total weight of said external coating.

Below 10% by weight of bentonite relative to the total weight of said external coating, the coating does not adhere to the fibre, whereas above 35% by weight of bentonite relative to the total weight of said external coating, the fibre thus coated is no longer flexible enough.

By fiberisable material, it should be understood a material enabling fiberising, i.e. which can undergo a transformation of a bulk fiberisable material. It may consist of a vitreous material having a glass transition enabling stretching thereof.

Preferably, the core may be made of a material selected from among glass-transition materials and sapphire glass.

Advantageously, the core may be made of a material selected from among glass-transition materials and sapphire glass.

According to an advantageous first embodiment of the present invention, the external coating, the fibre according to the invention could further comprise a protective sheath made of a polymeric material surrounding the core over at least one portion of the length of the fibre, the protective sheath having an inner surface in contact with the core and an outer surface in contact with the external coating.

According to an advantageous second embodiment of the present invention, the external coating could be directly in contact with the core.

Advantageously, irrespective of the considered embodiment, the core (11) of the fibre may have a diameter comprised between 100 μm and 10 mm, preferably between 100 μm and 140 μm, and better still in the range of 125 μm.

Advantageously, irrespective of the considered embodiment, the external coating may have a thickness comprised between 5 and 240 μm. If the core is cylindrical shaped, the thickness of the external coating will then be a radial thickness comprised between 5 and 240 μm.

In the context of the present invention, the fibre according to the invention could preferably be an optical fibre.

Another object of the present invention is an optical component comprising one or more optical fibre(s) according to the invention.

As optical components according to the invention, mention may in particular be made of multicore fibres, microstructured fibres, taper fibres (or “taper” in English), optical couplers with one or more fibre(s) at the inlet and one or more fibre(s) at the outlet, laser fibres, and fibre-based Bragg gratings, without this list being limiting.

The Applicant has developed a method for manufacturing such a fibre.

To this end, the Applicant has developed a method for manufacturing a pasty composition for fibre coating, comprising the following steps:
A) dispersing in water a dry mixture of hexagonal boron nitride BN and bentonite to ensure a proper mixing of bentonite and boron nitride, the dry mixture comprising at least 10% by weight of bentonite relative to the total weight of said dry mixture, to form an aqueous suspension;
B) evaporating the water contained in said aqueous suspension, until obtaining a pulverulent dry extract;
C) dispersing said pulverulent dry extract in water to form a pasty composition, in a proportion of at least 40% by weight of dry extract in water.

Advantageously, step B) of the method for manufacturing a pasty composition for fibre coating according to the invention could be carried out under a primary vacuum or under atmospheric pressure, and at a temperature that could be comprised between 50° C. and 90° C., preferably between 60° C. and 80° C., and better still in the range of 60° C.

Another object of the present invention is a pasty composition for fibre coating that could be obtained by the aforementioned manufacturing method.

Advantageously, the pasty composition according to the invention could further comprise a dopant, which could advantageously be based on carbon, zirconium oxides, titanium oxides and metal or semiconductor nanoparticles, organic fillers (organic and organometallic molecular compounds), inorganic fillers and mixtures thereof.

Thus, another object of the present invention is a method for manufacturing a fibre according to the invention implementing such a pasty composition to obtain the deposition of an external coating 2 over the outer surface 111, 121 of a fibre 1, the method comprising the following steps:
A) providing or making a fibre core 11 made of a fiberisable material, said core 11 covered or not covered with a protective sheath 12;
B) providing a pasty composition for fibre coating according to the invention;
C) coating at least one portion of said fibre 1 with said pasty composition (20) so as to form a wet layer 21 over said fibre 1;
D) heat treating said optical fibre 1 coated with said wet layer 21 at a temperature comprised between 100° C. and 250° C. for a time period enough to form an external coating layer 2 that could be handled (in this case wound and handled).

Advantageously, steps C and D may be reiterated once or several times until obtaining the desired thickness of the external coating.

According to an advantageous first embodiment of the method for manufacturing a fibre according to the invention, step A) could be a step of providing a fibre comprising a core made of a fiberisable material and covered with a protective sheath, such that steps B to D will be carried out after manufacture of the fibre (1); and the heat treatment step D) will consist in drying carried out in an oven at 100° C.

According to this first embodiment, the method for manufacturing a fibre according to the invention may further comprise a step A′ of stripping the fibre according to the invention, to pull off the protective sheath, over at least one portion of the length of the fibre. Preferably, this step A′ may be carried out by contacting the protective sheath with a dichloromethane solution, in the case of a protective sheath made of polyacrylate. Other methods of stripping the fibre are possible, for example by mechanical stripping with a clamp or a razor blade. Nonetheless, as regards optical fibres intended to be handled at least once, it is preferable to consider a chemical stripping.

According to an advantageous second embodiment of the method for manufacturing a fibre according to the invention, step A) could consist of a step of making a fibre on a fiberising tower.

According to the second embodiment, step B of coating the pasty composition could be carried out in a die holder arranged under the first vertical oven in a static condition and the heat treatment step D could be carried out in a second vertical oven located under the first vertical furnace and the die holder.

Other advantages and particularities of the present invention will arise from the following description, given as a non-limiting example and made with reference to the appended figures and to the examples.

### BRIEF DESCRIPTION OF THE FIGURES

The following examples illustrate the invention, in connection with the figures discussed hereinabove, yet without limiting the scope thereof:

FIG. 1 comprises a cross-sectional view (1A) and a perspective view (1B) of a first example of a fibre according to the invention (fibre without protection sheath).

FIG. 2 comprises a cross-sectional view (2A) and a perspective view (2B) of a second example of a fibre according to the invention (fibre with protective sheath).

FIG. 3 schematically shows a device for implementing the method for manufacturing a fibre according to the second embodiment, i.e. a method in which the coating pasty composition is applied on a fiberising tower.

FIG. 4 comprises two optical microscope photographs of the fibre 1 obtained in Example 2 (post-process) covered by an external coating 2 based on hexagonal boron nitride and bentonite after a heat treatment at 1,000° C., at different focusing distances (4A on the edges of the fibre and 4B at the surface of the fibre).

FIG. 5 shows the relative variation over time of the response of a Bragg grating (DI/I) at 800° C. for 800 hours, for a bare fibre (continuous line) and a fibre according to the invention, provided with a coating comprising three layers of BN (dotted lines).

FIG. 6 comprises two optical microscope photographs of the fibre 1 obtained in Example 4 (fiberising tower), covered by an external coating 2 based on hexagonal boron nitride and bentonite and having undergone a heat treatment at 800° C.: the first photograph corresponds to the fibre obtained just upon completion of the heat treatment at 800° C. (6A), the other photograph (6B) corresponding to the fibre obtained upon completion of a liquid nitrogen quenching for 2 hours at −195.72° C. subsequent to the heat treatment.

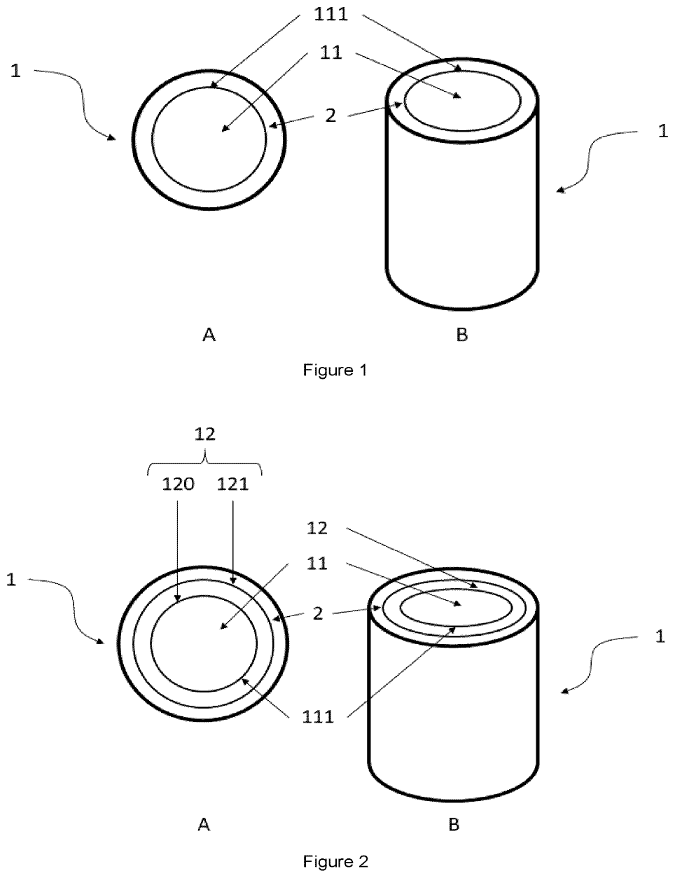

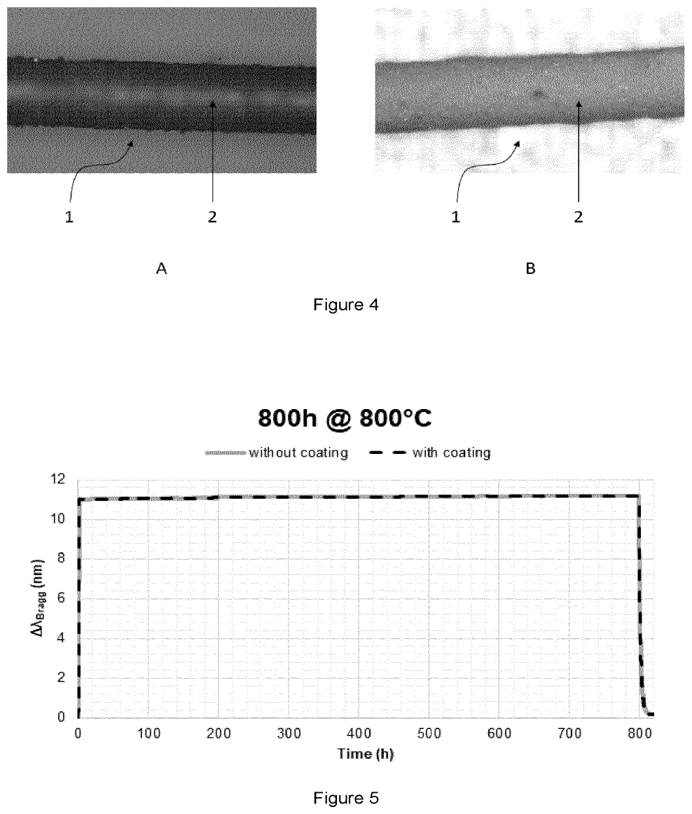

FIGS. 1 and 2 are described in more detail hereinafter, whereas FIGS. 4 to 6 are described in more detail in the following examples, which illustrate the invention without limiting its scope

### DETAILED DESCRIPTION OF THE FIGURES

FIGS. 1A and 1B show a first example of a fibre 1 according to the invention (fibre without protective sheath), which comprises a core 11 made of a fiberisable material and having an outer surface 111, which is covered by an external coating 2 based on hexagonal boron nitride and bentonite.

FIGS. 2A and 2B show a second example of a fibre according to the invention (fibre with protective sheath), which differs from that one shown in FIGS. 1A and 1B in that it further comprises a protective sheath 12 made of a polymeric material surrounding the core 11 over at least a specific portion of the fibre (over the entire length in the case of the example illustrated in FIG. 2), the protective sheath 12 having an inner surface 120 in contact with the core 11 and an outer surface 121 in contact with the external coating 2.

### EXAMPLES

The nature of the products used for the manufacture of the fibres according to the invention and the implemented method, as well as the characterisation methods are detailed hereinafter.

### Products, Raw Materials

solvent for chemical stripping: dichloromethane, isopropanol;
hexagonal BN powder;
bentonite of general formula Al₂H₂O₁₂Si₄;
optical fibre samples (in particular made of silica, sapphire, or chalcogenide) comprising a protective sheath made of organic polymer (for example made of polyacrylate);
glass preforms.

### Structural and Microstructural Characterisation Devices and Tests

A complete physicochemical characterisation has been carried out with complementary techniques at different scales to characterise the applied coating layer using:
optical microscopy,
Ray Diffraction (XRD) analysis,
high temperature resistance test comprising heating of the fibre samples according to the invention at 1,000° C., with a heating ramp at 10° C./min, followed by inertia or instantaneous cooling;
low temperature resistance test comprising heating of the fibre samples according to the invention at 800° C., with a heating ramp at 10° C./min, followed by cooling to room temperature by inertia, and then quenching in liquid nitrogen, to −195.72° C., for two hours;
determination of the behaviour of the Bragg response of the fibre samples according to the invention by analysing the reflectivity at the Bragg wavelength via a broadband laser source and an optical spectrum analyser.

### Example 1

### Manufacture of an Example of Pasty Composition C for Fibre Coating

Boron nitride and benonite (in a proportion of at least 10% by weight of bentonite) are ground using a planetary mill, with reversal of the direction of rotation every 5 minutes (for a satisfactory grain size distribution).

The ground product thus obtained is dispersed in a large amount of water (about 250 mL) to form a suspension.

The suspension thus obtained is evaporated to dryness in a 500 mL Schlenk tube. The evaporation is done under a primary vacuum (10⁻³ Pa) using a vacuum/argon manifold. Throughout the duration of the operation, the Schlenk tube is maintained at 60° C. in a water bath, via an oil bath. After 4 to 6 hours of evaporation: the dry obtained extract is manually ground (with mortar and pestle).

The obtained powder may be stored in an oven at 50° C. or in a desiccator for several months.

At the time of performing the deposition over the fibre, the obtained powder is dispersed in at least 20 mL of distilled water.

The pasty composition according to the invention C is obtained.

### Example 2

### Manufacture of a Coated Fibre According to the Invention in Accordance With a First Embodiment in Post-Process

### Step A

Commercial optical fibre samples (in particular made of silica, sapphire, or chalcogenide) are used comprising a protective sheath made of polyacrylate which are stripped in a step A′.

### Step A′

It should be recalled that, during manufacture thereof, the optical fibres are conventionally protected by organic polymers: without this protective coating, the optical fibres are extremely vulnerable to mechanical contacts, making them difficult to handle. Yet, this organic coating is by nature incompatible with a deployment of the optical fibre in a severe environment.

Hence, it is preferable to at least partially pull off this coating. Preferably, this stripping operation A′ is carried out by a chemical attack. The interest of this step A′ is to strip a specific portion of the optical fibre, either at one end or over an area defined beforehand. In general, at each end of the fibre, the initial coating is kept over a sufficient length so as to be able at least to hold the fibre in position during the step of depositing the coating without weakening. The lengths are adjusted according to the targeted application type.

The used solvent is dichloromethane, in the case of a polyacrylate-type original protective sheath (standard case).

If the commercial optical fibre samples comprise a protective sheath made of a polymer other than a polyacrylate and which is not sensitive to dichloromethane, another solvent capable of dissolving this polymer will be used. For example, if the protective sheath is made of polyimide, hydrochloric acid or hot sulphuric acid will be used to dissolve it.

Step A′ of chemical stripping allows avoiding weakening the fibre, unlike a mechanical stripping (with a clamp or with a razor blade).

For some applications, it might be preferable to keep the original protective sheath of the optical fibre (polyacrylate or poly-imide, deposited during manufacture of the optical fibre, or in post-process). The BN and bentonite based coating 2 in accordance with the present invention could then directly coat the unstripped fibre. Hence, in this case, the stripping step A′) is not carried out.

### Step B

The Pasty Composition C of Example 1 Is Used.

### Step C

It is then proceeded with coating of at least one portion of a stripped fibre sample with the pasty composition C so as to form a wet layer over the fibre, for example by immersion.

### Step D

Afterwards, the sample is placed in an oven at 100° C. The coating is dry at touch after 15 seconds. After this treatment, the fibre could be wound on a standard coil (typically with a 158 mm radius).

### Example 3

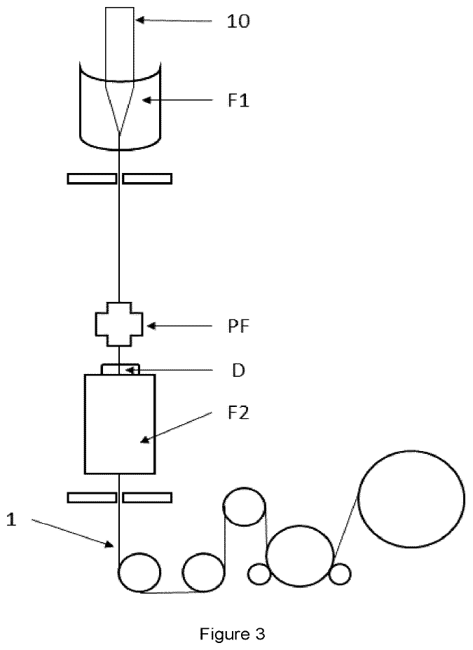

Manufacture of a Coated Fibre According to the Invention in Accordance With a Second Embodiment in a Fiberising Tower (cf. FIG. 3)

For some applications, the optical fibre is interesting on its own. The specificity required for the application lies in the even manufacture of the fibre (for example, a preform having a specific composition elating Rayleigh scattering). The lengths implemented for these applications are rather a few tens of metres, up to several kilometres. In this case, it is preferable to deposit the BN and bentonite based coating directly when fiberising the preform, i.e. on a fiberising tower.

To this end, a fiberising tower as shown in FIG. 3 is used.

### Step A

A glass preform 10 is inserted into an oven F1 heated to a temperature of about 2,000° C. Under the effect of heat and gravity, the glass softens and leads to the formation of a “drop”. As it is refined, the preform forms, by homothety, a glass fibre 11 which forms the core of the fibre 1 according to the invention. This fibre is conventionally coated with polyacrylate injected under pressure and crosslinked by UV and is then driven by a capstan at a controlled speed.

### Step B

The pasty composition C is used.

### Step C

The pasty composition C is applied on the fibre at atmospheric pressure, or under overpressure. A standard die holder PF, provided with its diffuser, is used to contain the pasty composition. The diffuser has no other interest than reducing the outlet diameter of the die holder. The volume required to cover 100 m of a 125 μm diameter fibre is estimated at 10 mL.

### Step D

A tubular oven F2 is placed vertically at 220 mm below the die holder PF. The hot area is about 250 mm. The temperature of the oven is 250° C. A diaphragm D is placed on the top outlet of the oven to avoid heat-up of the die holder.

### Fiberising Parameters

The fiberising parameters to be controlled to ensure a proper deposition of the coating are: the speed, and the temperature of the drying oven (herein F2). These two parameters depend on the used hardware. The fiberising speed should be comprised between 4 and 8 m/min. Below 4 m/min, the coating does not adhere to the fibre. Irrespective of the selected speed, the temperature should not be lower than 250° C. Higher deposition speeds may be considered with the use of an oven with a heating area larger than 20 cm.

### Example 4

### Characterisation of the Coatings According to the Invention

Afterwards, different tests have been carried out to characterise the BN and bentonite coatings in accordance with the invention.

In order to reveal any physicochemical modifications of the coating (prohibitive for the targeted applications), the samples are observed under an optical microscope, characterised in XRD, and under different temperature conditions. The optomechanical behaviour is also studied.

A first temperature resistance test of the coatings formed in Example 3 has been carried out at 1,000° C. raised at 10° C. /min up to 1,000° C., for a duration of 500 hours, and then cooling by inertia. FIG. 4 is an observation of the sample under an optical microscope after this heat treatment. These observations show that the coating features no alteration of its integrity (crack or fracture).

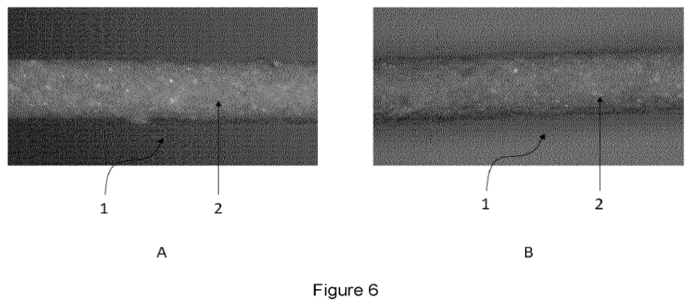

The behaviour of this coating at low temperature has also been studied. For this purpose, it has been subjected to a heat treatment at 800° C. to stabilise the coating, then to an immersion by quenching in liquid nitrogen, at −195.72° C., for two hours. No chemical or physical degradation has been observed, as illustrated in the photos of FIG. 6.

Other fibre samples having coated Bragg gratings BN are also studied under different isotherms (at high and low temperatures), in order to validate the criterion of non-modification of the optomechanical properties of the fibre. Indeed, it is essential that the coating does not alter the sensitivity of the sensor it protects. Successive heating and cooling cycles are also repeated on samples with and without coating in order to validate the proper dynamic behaviour (thermal expansion of the different materials).

Likewise, the behaviour of the Bragg response is compared with and without coating, as illustrated in FIG. 5 during a cycle over more than 800 hours at 800° C.

### LIST OF THE REFERENCES

1. WO2020/222152 (2019-08-27)—“Boron nitride nanotube coated optical waveguide and uses thereof”—NRC—NATIONAL RESEARCH COUNCIL CANADA
2. Xin'gang Luan, Xinming Xu, Min Li, Rong Yu, Qiqi Zhang, Sam Zhang and Laifei Cheng. “Design, preparation, and properties of a boron nitride coating of silica optical fibre for high temperature sensing applications”. Journal of Alloys and Compounds, Volume 850, 5 Jan. 2021, 156782.
3. Xin'gang Luan, Rong Yu, Qiqi Zhang, Sam Zhang and Laifei Cheng. “Boron nitride coating of sapphire optical fibre for high temperature sensing applications”. Surface and Coatings Technology, Volume 363, 15 Apr. 2019, pages 203-209.
4. Xin'gang Luan, Xinming Xu, Rong Yu, Qiqi Zhang, Sam Zhang and Laifei Cheng. “BN/SiBCN light-leakage-proof coatings of silica optical fibre for long term sensors at high temperatures”. Chinese Journal of Aeronautics, Volume 34, Issue 5, May 2021, pages 93-102.

1. A fibre, comprising:
a core comprising a fiberisable material and having an outer surface; and
an external coating including a mixture of hexagonal boron nitride and bentonite, in a proportion of at least 10% by weight of bentonite relative to the total weight of the external coating.

2. The fibre of claim 1, wherein the core comprises a material selected from glass-transition materials and sapphire glass.

3. The fibre of claim 1, further comprising:
a protective sheath comprising a polymeric material surrounding the core over at least one portion of the length of the fibre, the protective sheath having an inner surface in contact with the core and an outer surface in contact with the external coating.

4. The fibre of claim 1, wherein the external coating is directly in contact with the core.

5. The fibre of claim 1, wherein the core has a diameter between 100 μm and 10 mm.

6. The fibre of claim 1, wherein the external coating has a thickness between 5 and 240 μm.

7. The fibre of claim 1, which is an optical fibre.

8. An optical component, comprising one or more optical fibre(s) of claim 7.

9. A method for manufacturing the fibre of claim 1, the method comprising:
A) providing or making a fibre core of comprising a fiberisable material, the core optionally covered with a protective sheath
B) providing a pasty composition for fibre coating obtained according to a method for manufacturing a pasty composition for fibre coating;
C) coating at least one portion of the fibre with the pasty composition to form a wet layer over the fibre; and
D) heat treating the fibre coated with the wet layer at a temperature between 100° C. and 250° C. for a time period long enough to form an external coating layer that could be handled.

10. The method of claim 9, wherein C) and D) are reiterated once or several times until obtaining a desired thickness of the external coating.

11. The method of claim 9, wherein:
step A) comprises providing a fibre comprising a core comprising a fiberisable material and which is covered with a protective sheath, such that
steps B to D B), C), and D) are carried out after manufacture of the fibre; and
the heat treatment comprises drying in an oven at 100°C.

12. The method of claim 11, wherein the protective sheath is, during a step A′), the fibre according to the and prior to B), at least partially removed over a specific length of the fibre to remove the protective sheath over at least one portion of the length of the fibre.

13. The method of claim 9, wherein A) comprises making a fibre on a fiberising tower.

14. The manufacturing method of claim 9, wherein B) comprises:
i. dispersing in water a dry mixture of hexagonal boron nitride BN and bentonite; in a proportion of at least 10% by weight of bentonite relative to the total weight of the dry mixture, to form an aqueous suspension;
ii. evaporating the water contained in the aqueous suspension, until obtaining a pulverulent dry extract; and
iii. dispersing the pulverulent dry extract in water to form a pasty composition, in a proportion of at least 40% by weight of dry extract in water.

15. A pasty composition for a fibre coating obtained by a method comprising:
i. dispersing in water a dry mixture of hexagonal boron nitride BN and bentonite, in a proportion of at least 10% by weight of bentonite relative to the total weight of the dry mixture, to form an aqueous suspension;
ii. evaporating the water contained in the aqueous suspension, until obtaining a pulverulent dry extract; and
iii. dispersing the pulverulent dry extract in water to form a pasty composition, in a proportion of at least 40% by weight of dry extract in water.
